(19) United States
(12) Patent Application Publication
(10) Pub. No.: US 2016/0217602 A1
(43) Pub. Date: Jul. 28, 2016

(54) METHOD FOR GENERATING EIA AND APPARATUS CAPABLE OF PERFORMING SAME

(71) Applicant: SAMSUNG ELECTRONICS CO., LTD., Gyeonggi-do (KR)

(72) Inventors: Shaohui JIAO, Suwon-si (KR); Mingcai ZHOU, Suwon-si (KR); Tao HONG, Suwon-si (KR); Weiming LI, Suwon-si (KR); Haitao WANG, Suwon-si (KR); Ji Yeun KIM, Suwon-si (KR); Shandong WANG, Suwon-si (KR)

(73) Assignee: Samsung Electronics Co., Ltd., Gyeonggi-do (KR)

(21) Appl. No.: 14/916,437

(22) PCT Filed: May 2, 2014
(86) PCT No.: PCT/KR2014/003911

§ 371 Date: Mar. 3, 2016

(51) Int. Cl. G06T 15/00; H04N 13/02; G06T 1/20

(52) U.S. Cl. CPC G06T 15/005; G06T 1/20; H04N 13/0203

(57) ABSTRACT

A display system, according to one embodiment, comprises a display panel for displaying the EIA, a lens array positioned at the front part of the display panel, a depth camera for generating a depth image by photographing a user. The display system may include an image processor for calculating a viewing distance between the user and the display system from the depth image, generating a plurality of ray clusters corresponding to one view point according to the viewing distance, generating a multi-view image by rendering the plurality of ray clusters, and generating the EIA on the basis of the multi-view image.

### CROSS REFERENCE TO RELATED APPLICATIONS

This application is a National Stage Application of PCT/KR2014/003911 filed on May 2, 2014, which claims priority to Chinese Application No. 201310397971.x filed on Sep. 4, 2013 and Korean Application No. 10-2013-0167449 filed on Dec. 30, 2013, the entire contents of each of which are hereby incorporated by reference.

### TECHNICAL FIELD

Example embodiments relate to a method of generating an elemental image array (ETA) and an apparatus for performing the method.

### BACKGROUND

An integral imaging display may refer to a display technology that enables a user to view a three-dimensional (3D) image with the naked eye. The 3D image may have a continuous parallax change in a horizontal and a vertical direction.

An integral imaging display system may include a liquid crystal display (LCD) panel and a lens array. The integral imaging display system may display an EIA, which is a two-dimensional (2D) image, on the LCD panel and generate a 3D image by refracting different portions of the EIA into 3D space at different directions through the lens array.

### SUMMARY

Example embodiments provide technology that may reconstruct optimal light field rays corresponding to one viewpoint based on a viewing distance.

Example embodiments also provide technology that may reduce a rendering time by performing single pass parallel rendering on the reconstructed light field rays, thereby generating a high-resolution multiview image quickly.

According to example embodiments, there is provided a display system including a display panel to display an elemental image array (EIA), a lens array disposed in a front portion of the display panel, a depth camera to generate a depth image by photographing a user, and an image processing device to calculate a viewing distance between the user and the display system based on the depth image, generate multiple ray clusters corresponding to one viewpoint based on the viewing distance, generate a multiview image by rendering the multiple ray clusters, and generate the EIA based on the multiview image.

The image processing device may adjust a pixel width of the display panel based on the EIA.

The image processing device may include a ray cluster generating unit to calculate the viewing distance based on the depth image, generate the multiple ray clusters based on the viewing distance, and calculate rendering parameters of the multiple ray clusters, a transformation matrix generating unit to generate a transformation matrix using user interactive data, and a graphics processing unit (GPU) to generate the multiview image by performing single pass parallel rendering on the multiple ray clusters using the rendering parameters and the transformation matrix and generate the EIA based on the multiview image.

The GPU may generate the multiview image by performing geometry duplication on a three-dimensional (3D) content.

The GPU may perform multi-sampling anti-aliasing on the multiview image.

The GPU may perform a clipping operation on the multiview image.

The ray cluster generating unit may calculate the rendering parameters based on the viewing distance, parameters of the display panel, and parameters of the lens array.

The depth camera may generate the depth image by photographing the user in real time, and the image processing device may generate the multiple ray clusters optimized based on the viewing distance calculated in real time using the depth image.

The image processing device may perform pixel rearrangement on the multiview image and generate the EIA.

According to example embodiments, there is also provided a method of generating an elemental image array (EIA) of a display system, including calculating a viewing distance between a user and the display system using a depth image obtained by photographing the user, generating multiple ray clusters corresponding to one viewpoint based on the viewing distance, generating a multiview image by rendering the multiple ray clusters, and generating the EIA based on the multiview image.

The method may further include adjusting a pixel width of a display panel of the display system based on the EIA.

The generating of the multiview image may include performing geometry duplication on a 3D content and translating the 3D content on which the geometry duplication is performed to the multiple ray clusters based on a transformation matrix using user interactive data.

The generating of the multiview image may include performing multi-sampling anti-aliasing on the multiview image.

The generating of the multiview image may include performing a clipping operation on the multiview image.

The generating of the multiview image may include performing single pass parallel rendering on the multiple ray clusters.

The generating of the EIA may include performing pixel rearrangement on the multiview image.

The user interactive data may include at least one of 3D interactive data and two-dimensional (2D) interactive data.

### BRIEF DESCRIPTION OF THE DRAWINGS

FIG. 1 is a diagram illustrating a display system according to example embodiments.

FIGS. 2A and 2B are diagrams illustrating operations of the ray cluster generating unit of FIG. 1.

FIG. 3 is a block diagram illustrating the graphics processing unit (GPU) of FIG. 1.

FIG. 4 illustrates an operation of the geometry shader of FIG. 3.

FIG. 5 illustrates a clipping operation of the fragment shader of FIG. 3.

FIG. 6 illustrates a pixel rearranging operation of the fragment shader of FIG. 3.

FIG. 7 is a flowchart illustrating an operation of the display system of FIG. 1.

### DETAILED DESCRIPTION

Hereinafter, example embodiments will be described in detail with reference to the accompanying drawings.

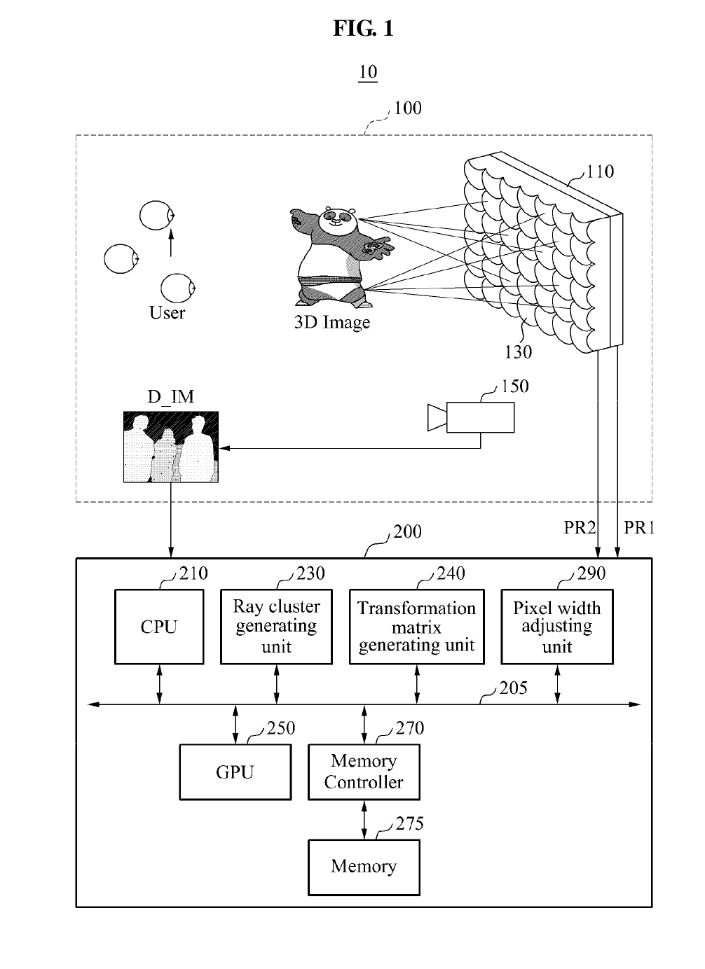

FIG. 1 is a diagram illustrating a display system 10 according to example embodiments.

Referring to FIG. 1, the display system 10 may include a display device 100 and an image processing device 200. The display system 10 may refer to an interactive system that may interact with a user, or a viewer. Also, the display system 10 may be a naked-eye three-dimensional (3D) display system.

The display device 100 may generate a 3D image based on an elemental image array (EIA) generated by the image processing device 200. The display device 100 may include a display panel 110, a lens array 130, and a depth camera 150.

The display panel 110 may display the EIA generated by the image processing device 200. The display panel 110 may transmit display panel parameters (PR1) to the image processing device 200. For example, the display panel parameters may include a distance between the lens array 130 and the display panel 110 and a pixel size or a pixel width of the display panel 110.

For example, the display panel 110 may be provided in a form of a liquid crystal display (LCD) panel. Also, the display panel 110 may be provided in a form of a touch screen panel, a thin film transistor liquid crystal display (TFT-LCD) panel, a light emitting diode (LED) display panel, an organic LED (OLED) display panel, an active matrix OLED (AMOLED) display panel, or a flexible display panel.

The lens array 130 may refract rays emitted from an EIA and generate a 3D image. The lens array 130 may transmit lens array parameters (PR2) to the image processing device 200. For example, the lens array parameters may include a number of lenses in the lens array 130, a focal distance, a distance between the lens array 130 and the display panel 110, and a pitch of the lens array 130, for example, a distance between a light center and each of adjacent lenses.

The depth camera 150 may be disposed in a screen of the display system 10. The depth camera 150 may be adjacent to the lens array 130 and disposed on the lens array 130. The depth camera 150 may photograph the user and generate a depth image (D_IM). The depth camera 150 may transmit the depth image to the image processing device 200.

According to an embodiment, the depth camera 150 may photograph the user in real time, generate the depth image, and transmit the depth image to the image processing device 200 in real time.

The image processing device 200 may control an overall operation of the display system 10. The image processing device 200 may include a printed circuit board (PCB) such as a motherboard, an integrated circuit (IC), or a system on chip (SoC). For example, the image processing device 200 may be an application processor.

The image processing device 200 may calculate the viewing distance using the depth image and generate multiple ray clusters corresponding to one viewpoint based on the calculated viewing distance. For example, the image processing device 200 may calculate rendering parameters of the multiple ray clusters based on the viewing distance, the display panel parameters, and the lens array parameters. The viewing distance may refer to a distance between the user and the display system 10.

The image processing device 200 may perform single pass parallel rendering on the multiple ray clusters and generate a multiview image. For example, the image processing device 200 may generate the multiview image by performing the single pass parallel rendering on the multiple ray clusters using a transformation matrix based on the rendering parameters and user interactive data.

The image processing device 200 may generate the EIA by performing pixel rearrangement on the multiview image. The image processing device 200 may transmit the EIA to the display device 100.

The image processing device 200 may further include a central processing unit (CPU) 210, a ray cluster generating unit 230, a transformation matrix generating unit 240, a graphics processing unit (GPU) 250, a memory controller 270, and a memory 275. The image processing device 200 may further include a pixel width adjusting unit 290.

The CPU 210 may control an overall operation of the image processing device 200. For example, the CPU 210 may control an operation of components 230, 240, 250, 270, and 290, respectively, through a bus 205.

According to an embodiment, the CPU 210 may include a multicore. The multicore may be a computing component having two or more independent cores.

The ray cluster generating unit 230 may calculate the viewing distance using the depth image. The ray cluster generating unit 230 may update the viewing distance based on a location of the user while the depth camera 150 is photographing the user and transmitting the depth image in real time.

The ray cluster generating unit 230 may obtain a viewing range corresponding to the viewing distance, for example, an optimized light field, by calculating the viewing distance.

The ray cluster generating unit 230 may perform clustering on light field rays in a light field based on the viewing distance and generate the multiple ray clusters corresponding to one viewpoint. The ray cluster generating unit 230 may reconstruct the light field rays to correspond to one viewpoint using the multiple ray clusters.

The ray cluster generating unit 230 may reconstruct optimal light field rays corresponding to one viewpoint based on the viewing distance that may be updated based on the location of the user.

The ray cluster generating unit 230 may calculate the rendering parameters of the multiple ray clusters corresponding to one viewpoint based on the viewing distance, the display panel parameters, and the lens array parameters. The ray cluster generating unit 230 may transmit the rendering parameters to the GPU 250.

The transformation matrix generating unit 240 may receive the user interactive data and 3D data from the memory 275. The user interactive data may include data generated by at least one of a 3D capturing operation and a two-dimensional (2D) keyboard/mouse operation, for example, rotation, movement, and scaling. For example, the interactive data may include at least one of 3D interactive data and 2D interactive data. The 3D data may include a geometric feature, a material, and a texture of a 3D content to be displayed.

The transformation matrix generating unit 240 may generate 3D data, for example, a transformation matrix that may control the 3D data, using the user interactive data. The transformation matrix may include position transformation information on the 3D content, for example, movement and/or rotation. The transformation matrix may be a translation matrix of the 3D content. The transformation matrix generating unit 240 may transmit the transformation matrix to the GPU 250.

The GPU 250 may perform an operation related to graphics processing to reduce a load on the CPU 210.

The GPU 250 may perform the single pass parallel rendering on the multiple ray clusters corresponding to one viewpoint using the rendering parameters and the transformation matrix and generate the multiview image.

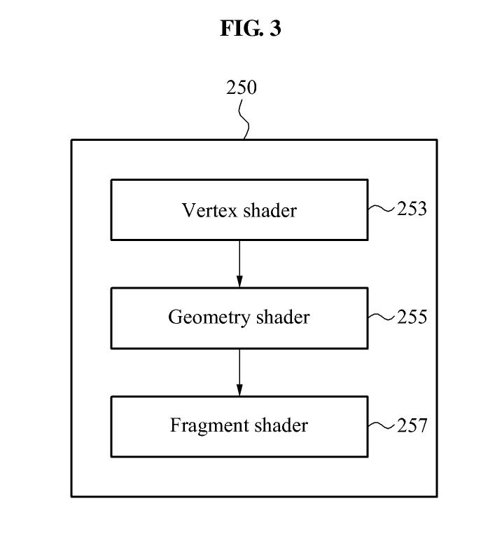

Also, the GPU 250 may perform the pixel rearrangement on the multiview image and generate the EIA. A detailed description of the operation of the GPU 250 will be provided with reference to FIG. 3.

The memory controller 270 may transmit 3D data stored in the memory 275 to the CPU 210 and/or the GPU 250 based on a control by the CPU 210.

The memory 290 may store the 3D data. For example, the 3D data may include a geometric feature, a material, and a texture of the 3D content to be displayed. For example, the 3D content may include a polygonal grid and/or texture. Although the memory 275 is provided in the image processing device 200 as illustrated in FIG. 1, the memory 275 may be an external memory that may be externally provided to the image processing device 200. The memory 275 may be a volatile memory device or a nonvolatile memory device.

The volatile memory device may include a dynamic random access memory (DRAM), a static random access memory (SRAM), a thyristor random access memory (T-RAM), a zero capacitor RAM (Z-RAM), or a twin transistor RAM (TTRAM).

The nonvolatile memory device may include an electrically erasable programmable read-only memory (EEPROM), a flash memory, a magnetic RAM (MRAM), a spin-transfer torque (STT) MRAM (STT-MRAM), a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate memory (NFGM), a holographic memory, a molecular electronics memory device, or an insulator resistance change memory.

The pixel width adjusting unit 290 may adjust a pixel width of the display panel 110 based on the EIA generated by the GPU 250. A description of a pixel width adjusting operation performed by the pixel width adjusting unit 290 will be provided hereinafter.

Although the ray cluster generating unit 230, the transformation matrix generating unit 240, and the pixel width adjusting unit 290 may be illustrated as separate intellectual properties (IPs) in FIG. 1, the ray cluster generating unit 230, the transformation matrix generating unit 240, and the pixel width adjusting unit 290 may be provided in the CPU 210.

The display system 10 may reconstruct the optimal light field rays corresponding to one viewpoint as the viewing distance is updated, and adaptively generate the EIA by performing the single pass parallel rendering on the reconstructed light field rays.

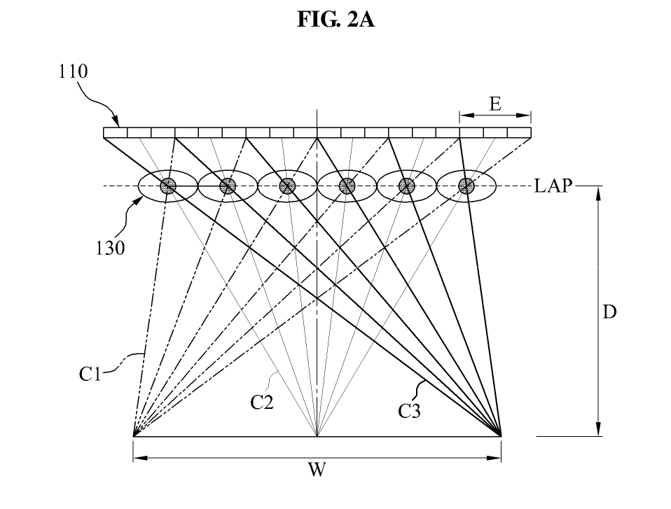

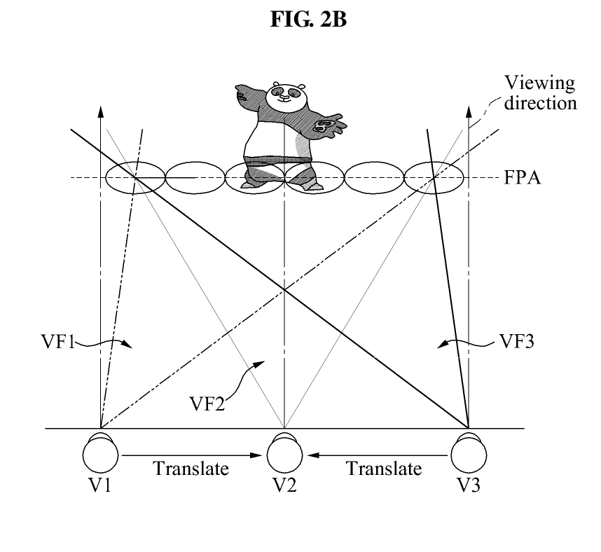

FIGS. 2A and 2B are diagrams illustrating an operation of the ray cluster generating unit 230 of FIG. 1.

In FIGS. 2A and 2B, three ray clusters C1, C2, and C3 in a horizontal direction and three view frustums VF1, VF2, and VF3, corresponding to the three ray clusters C1, C2, and C3 are illustrated for ease of description.

Referring to FIGS. 1 through 2B, the ray cluster generating unit 230 may perform clustering on light field rays in a light field based on a viewing distance (D) and generate the multiple ray clusters C1, C2, and C3 corresponding to one viewpoint, for example, a joint viewpoint.

The ray cluster generating unit 230 may calculate a viewing width (W) corresponding to the viewing distance. For example, the ray cluster generating unit 230 may calculate the viewing width based on Equation 1.

$$W = p \times \frac{( D + g )}{g} \qquad [ Equation 1 ]$$

In Equation 1, “p” may denote a lens pitch of the lens array 130 of FIG. 1, and “g” may denote a distance between the lens array 130 and the display panel 110 of FIG. 1. For example, g may indicate a distance between a light center of a lens in the lens array 130 and the display panel 110.

The ray cluster generating unit 230 may calculate a size, or a width (E), of an elemental image (EI). For example, the ray cluster generating unit 230 may calculate the width of the EI based on Equation 2.

$$E = W \times \frac{g}{D} \qquad [ Equation 2 ]$$

A number (n) of multiple ray clusters generated by the ray cluster generating unit 230 may be an integer, for example, a rounding integer, closest to a number of pixels included in a single EI. The ray cluster generating unit 230 may determine the number of the multiple ray clusters, for example, C1, C2, and C3, based on Equation 3.

$${n}_{x} ≅ \frac{E}{{p}_{d}} , {n}_{x} ∈ N \qquad [ Equation 3 ]$$

In Equation 3, “x” may denote a horizontal direction. “Pd” may denote a pixel pitch of the display panel 110. “nx” may denote a number of the multiple ray clusters C1, C2, and C3 in the horizontal direction. For example, the nx may be a non-zero integer.

“ny,” may denote a number of the multiple ray clusters in a vertical direction, and may be determined based on Equation 3.

As illustrated in FIG. 2A, light rays converging on one point of the viewing width may be grouped into one ray cluster of, for example, C1, C2, and C3.

As illustrated in FIG. 2B, the multiple ray clusters C1, C2, and C3 may correspond to view frustums VF1, VF2, and VF3, respectively. For example, multiple rays in a ray cluster C1 may correspond to a view frustum VF1. Multiple rays in a ray cluster C2 may correspond to a view frustum VF2. Similarly, multiple rays in a ray cluster C3 may correspond to a view frustum VF3.

Each of the view frustums VF1, VF2, and VF3 may be a perspective view frustum. Also, each of the view frustums VF1, VF2, and VF3 may be a shear perspective view frustum.

The view frustums VF1, VF2, and VF3 corresponding to the multiple ray clusters C1, C2, and C3 may have rendering parameters used for rendering.

The rendering parameters may include a viewpoint (Vi) and view angle (Θi) of each of the view frustums VF1, VF2, and VF3. The viewpoint may include an x coordinate and/or a y coordinate of the viewpoint. The view angle may be an angle of the view frustums VF1, VF2, and VF3 in a horizontal direction. For example, the view angle may be an angle of both lines of a view frustum VF1, VF2, or VF3. Here, “i” may denote a sequence of the multiple ray clusters C1, C2, and C3. For example, the i may be a sequence in the horizontal direction.

The viewpoint may be calculated based on Equation 4.

$${V}_{i} = - \frac{W}{2} + \frac{W}{{n}_{x} - 1} \times i \qquad [ Equation 4 ]$$

As illustrated in FIG. 2B, a viewpoint V1 may be a viewpoint of a view frustum VF1 and a viewpoint 2 may be a viewpoint of a view frustum VF2. Similarly, a viewpoint V3 may be a viewpoint of a view frustum VF3. For example, a set point of each of the multiple ray clusters C1, C2, and C3 may correspond to each viewpoint V1, V2, or V3 of the view frustums VF1, VF2, or VF3.

The view angle may be calculated based on Equation 5.

$${θ}_{i} = arctan ( \frac{L / 2 - p / 2 - {V}_{i}}{D} ) - arctan ( \frac{- L / 2 + p / 2 - {V}_{i}}{D} ) \qquad [ Equation 5 ]$$

In Equation 5, “L” may denote a width of the lens array 130 and “p” may denote a lens pitch of the lens array 130.

The sequence (i) of the multiple ray clusters C1, C2, and C3, for example, the sequence (i) in the horizontal direction, may satisfy Equation 6.

i∈(0,nₓ] [Equation 6]

The ray cluster generating unit 230 may translate the multiple ray clusters C1, C2, and C3 to a single joint viewpoint (V).

The ray cluster generating unit 230 may calculate the rendering parameters exclusively for one view frustum corresponding to the multiple ray clusters C1, C2, and C3 corresponding to one viewpoint, for example, the joint viewpoint.

The rendering parameters for one frustum, for example, the joint viewpoint and a joint view angle (Θ), may be represented by Equations 7 and 8.

$$\begin{matrix}V = ( 0 , 0 ) & [ Equation 7 ] \\ θ = 2 \cdot arctan ( \frac{( L - p ) \cdot {n}_{x}}{D} ) & [ Equation 8 ]\end{matrix}$$

As illustrated in FIG. 2B, the joint viewpoint may be the viewpoint V2. For example, the ray cluster generating unit 230 may generate the multiple ray clusters C1, C2, and C3 corresponding to the joint viewpoint, for example, the viewpoint V2. Also, the ray cluster generating unit 230 may calculate exclusive rendering parameters for one view frustum of the multiple ray clusters C1, C2, and C3 corresponding to the viewpoint V2.

The ray cluster generating unit 230 may indirectly obtain a direction of each ray in a light field by calculating the rendering parameters, without directly calculating the direction. When one frustum of the multiple ray clusters C1, C2, and C3 corresponding to the joint viewpoint is determined, the direction of each ray in the light field may be subsequently determined.

The ray cluster generating unit 230 may transmit the rendering parameters to the GPU 250.

FIG. 3 is a block diagram illustrating the GPU 250 of FIG. 1.

Referring to FIGS. 1 through 3, the GPU 250 may include a vertex shader 253, a geometry shader 255, and a fragment shader 257.

The vertex shader 253 may receive 3D data output from the memory 275 of FIG. 1 and process the 3D data. For example, the vertex shader 253 may process points of the 3D content. The vertex shader 253 may process the points by applying an operation such as a transformation, morphing, skinning, and/or lighting.

The geometry shader 255 may generate a multiview image by performing a first rendering. The geometry shader 255 may generate the multiview image by rendering multiple ray clusters C1, C2, and C3 corresponding to one viewpoint based on rendering parameters and transformation matrix (T). The geometry shader 255 may generate the multiview image by performing single pass parallel rendering on the multiple ray clusters C1, C2, and C3.

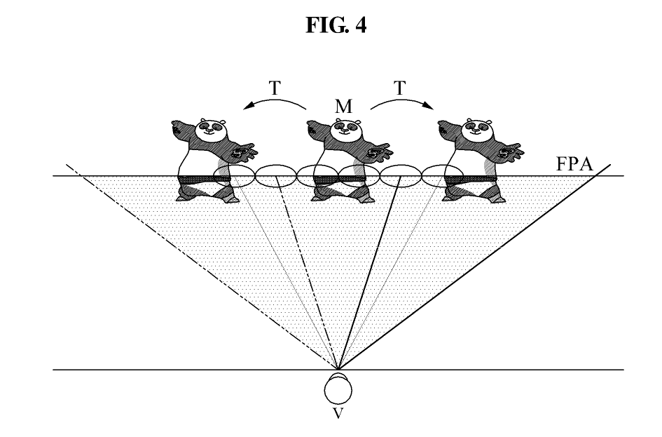

FIG. 4 illustrates an operation of the geometry shader 255 of FIG. 3.

Referring to FIG. 4, the geometry shader 255 may render one view frustum of multiple ray clusters C1, C2, and C3 corresponding to a single joint viewpoint (V) and obtain all color values of rays in a light field.

The geometry shader 255 may generate a multiview image through geometry duplication. For example, the geometry shader 255 may perform the geometry duplication on displayed 3D content (M), perform a transformation using a transformation matrix (T), and translate each of the multiple ray clusters C1, C2, and C3.

The geometry shader 255 may translate the 3D content on which the geometry duplication is performed using the transformation matrix. The transformation matrix may be represented by Equation 9.

$${T}_{{i}^{′} , {j}^{′}} = [ \begin{matrix}\frac{1}{{n}_{x}} & 0 & 0 & 0 \\ 0 & \frac{1}{{n}_{y}} & 0 & 0 \\ 0 & 0 & 1 & 0 \\ - \frac{W}{2} + ( \frac{W}{{n}_{x} - 1} ) \cdot {i}^{′} & - \frac{W}{2} + ( \frac{W}{{n}_{y} - 1} ) \cdot {j}^{′} & 0 & 1\end{matrix} ] \qquad [ Equation 9 ]$$

In Equation 9, “i” and “j” may denote a horizontal sequence and a vertical sequence of the 3D content on which the geometry duplication is performed, respectively, which may be represented by Equation 10.

i′=nₓ−i and j′=n_{y}−j [Equation 10]

The displayed 3D content may be represented by Equation 11.

M={v₁,v₂, . . . , v_{m},}vₖ∈M [Equation 11]

A 3D point (vk) of the displayed 3D content may be represented by Equation 12.

vₖ└xₖyₖzₖ1┘ [Equation 12]

In Equation 12, “xk, “yk,” and “zk” may denote x, y, and z coordinates of the 3D point of the displayed 3D content, respectively.

3D points (vi′, j′, and k) of 3D contents (Mi′, j′) on which the geometry duplication is performed may be calculated based on Equation 13.

v_{i′,j′,k}=vₖ·T_{i′,j′} [Equation 13]

The 3D contents on which the geometry duplication is performed may be represented by Equation 14.

M_{i′,j′}={v_{i′,j′,1},v_{i′,j′,m}} [Equation 14]

The geometry shader 255 may obtain the multiview image by performing the single pass parallel rendering. The multiview image may have an image resolution of

The geometry shader 255 may render the multiple ray clusters with one rendering pass and thus, a rendering time may be reduced and rapid generation of a high-resolution multiview image may be performed.

The fragment shader 257 of FIG. 3 may perform multi-sampling anti-aliasing (MSAA) on the multiview image and improve a quality of the multiview image. For example, the fragment shader 257 may perform 32×MASS on the multiview image.

The fragment shader 257 may perform a clipping operation on the multiview image.

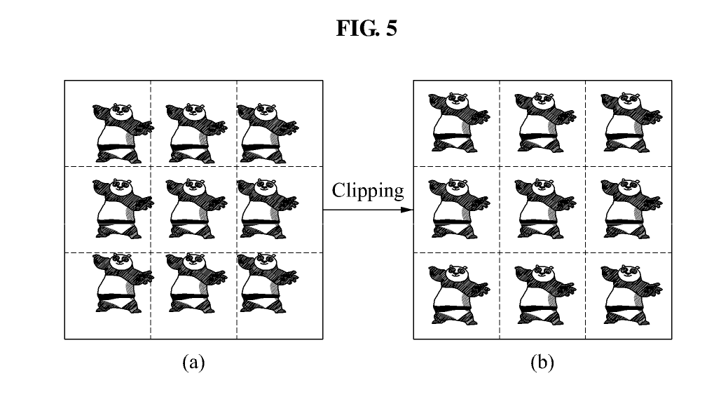

FIG. 5 illustrates a clipping operation of the fragment shader 257 of FIG. 3.

Referring to FIG. 5, the fragment shader 257 may perform a clipping operation and eliminate an artifact generated as multiple ray clusters corresponding to one viewpoint overlap.

The fragment shader 257 may perform a second rendering and generate an EIA. For example, the fragment shader 257 may generate the EIA by performing pixel rearrangement on a multiview image.

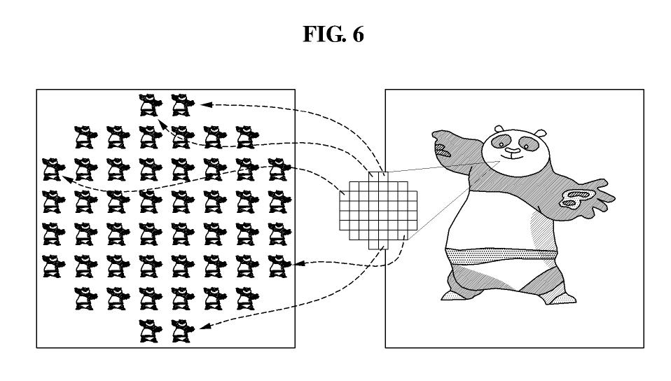

FIG. 6 illustrates a pixel rearranging operation of the fragment shader 257 of FIG. 3.

Referring to FIG. 6, the fragment shader 257 may perform pixel rearrangement.

The fragment shader 257 may transmit an EIA to the ray cluster generating unit 230 of FIG. 1.

The pixel width adjusting unit 290 of FIG. 1 may adjust a pixel width (Pd) of the display panel 110 of FIG. 1 based on the EIA generated by the GPU 250 of FIG. 1. When the pixel width does not match a size (E) of an EI included in the EIA, the pixel width adjusting unit 290 may adjust the pixel width. For example, the pixel width adjusting unit 290 may adjust the pixel width to be a value obtained by dividing a number (n) of multiple ray clusters by a lens pitch (p) of the lens array 130 of FIG. 1, which is indicated as “p/n.” The display panel 110 with the pixel width adjusted may display the EIA.

The display system 10 of FIG. 1 may display an accurate 3D image by adjusting the pixel width of the display panel 110.

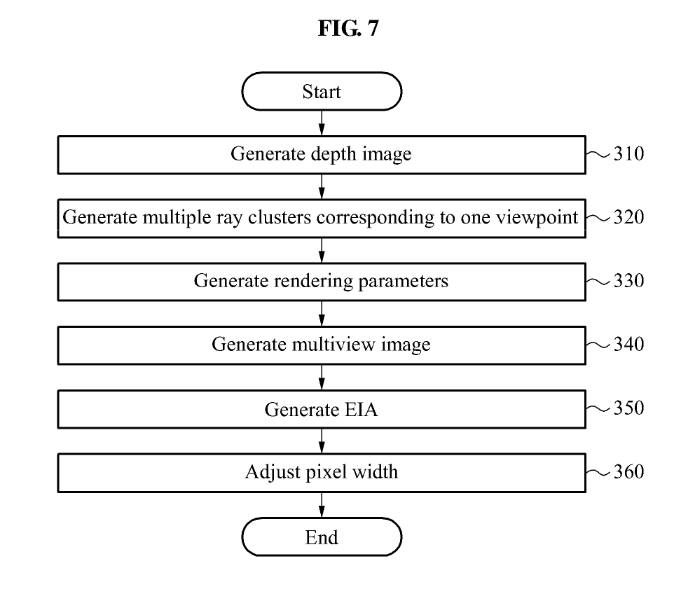

FIG. 7 is a flowchart illustrating an operation of the display system 10 of FIG. 1.

Referring to FIG. 7, in operation 310, the depth camera 150 of FIG. 1 generates a depth image (D_IM) by photographing a user.

In operation 320, the ray cluster generating unit 230 of FIG. 1 calculates a viewing distance using the depth image and generates multiple ray clusters corresponding to one viewpoint based on the viewing distance.

In operation 330, the ray cluster generating unit 230 generates rendering parameters of the multiple ray clusters corresponding to one viewpoint.

In operation 340, the GPU 250 of FIG. 1 generates a multiview image by performing single pass parallel rendering on the multiple ray clusters corresponding to one viewpoint using the rendering parameters and a transformation matrix (T).

In operation 350, the GPU generates an EIA by performing pixel rearrangement on the multiview image.

In operation 360, the pixel width adjusting unit 290 of FIG. 1 adjusts a pixel width of the display panel 110 of FIG. 1 based on the EIA.

Example embodiments include computer-readable media including program instructions to implement various operations embodied by a computer. The media may also include, alone or in combination with the program instructions, data files, data structures, tables, and the like. The media and program instructions may be those specially designed and constructed for the purposes of example embodiments, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. A display system, comprising:
a display panel configured to display an elemental image array (EIA);
a lens array in a front portion of the display panel;
a depth camera configured to generate a depth image by photographing a user; and
a processor configured to calculate a viewing distance between the user and the display system based on the depth image, generate multiple ray clusters corresponding to one viewpoint based on the viewing distance, generate a multiview image by rendering the multiple ray clusters, and generate the EIA based on the multiview image.

2. The system of claim 1, wherein the processor is configured to adjusts a pixel width of the display panel based on the EIA.

3. The system of claim 1, wherein the processor is configured to:
calculate the viewing distance based on the depth image, generate the multiple ray clusters based on the viewing distance, and calculate rendering parameters of the multiple ray clusters;
generate a transformation matrix using user interactive data; and
generate the multiview image by performing single pass parallel rendering on the multiple ray clusters using the rendering parameters and the transformation matrix and generate the EIA based on the multiview image.

4. The system of claim 3, wherein the processor is configured to generate the multiview image by performing geometry duplication on a three-dimensional (3D) content.

5. The system of claim 3, wherein the processor is configured to performs multi-sampling anti-aliasing on the multiview image.

6. The system of claim 3, wherein the processor is configured to performs a clipping operation on the multiview image.

7. The system of claim 3, wherein the processor is configured to calculates the rendering parameters based on the viewing distance, parameters of the display panel, and parameters of the lens array.

8. The system of claim 1, wherein the depth camera is configured to generates the depth image by photographing the user in real time, and
wherein the processor is configured to generates the multiple ray clusters optimized based on the viewing distance calculated in real time using the depth image.

9. The system of claim 1, wherein the processor is configured to performs pixel rearrangement on the multiview image and generates the EIA.

10. A method of generating an elemental image array (EIA) of a display system, the method comprising:
calculating a viewing distance between a user and the display system using a depth image obtained by photographing the user;
generating multiple ray clusters corresponding to one viewpoint based on the viewing distance;
generating a multiview image by rendering the multiple ray clusters; and
generating the EIA based on the multiview image.

11. The method of claim 10, further comprising:
adjusting a pixel width of a display panel of the display system based on the EIA.

12. The method of claim 10, wherein the generating a multiview image comprises:
performing geometry duplication on a three-dimensional (3D) content; and
translating the 3D content on which the geometry duplication is performed to the multiple ray clusters based on a transformation matrix using user interactive data.

13. The method of claim 10, wherein the generating a multiview image comprises performing multi-sampling anti-aliasing on the multiview image.

14. The method of claim 10, wherein the generating a multiview image comprises performing a clipping operation on the multiview image.

15. The method of claim 10, wherein the generating a multiview image comprises performing single pass parallel rendering on the multiple ray clusters.

16. The method of claim 10, wherein the generating the EIA comprises performing pixel rearrangement on the multiview image.

17. The method of claim 12, wherein the user interactive data comprises at least one of 3D interactive data and two-dimensional (2D) interactive data.

18. A non-transitory computer-readable medium comprising a computer readable instructions for instructing a computer to perform the method of claim 10.

19. The method of claim 10, further comprising:
calculating rendering parameters of the multiple ray clusters, wherein the generating a multiview image comprises generating the multiview image by performing single pass parallel rendering on the multiple ray clusters using the rendering parameters and a transformation matrix.

20. The method of claim 19, wherein the calculating rendering parameters comprises calculating the rendering parameters based on the viewing distance, parameters of a display panel for displaying the EIA, and parameters of a lens array associated with the display panel.
